(19) United States
(12) Patent Application Publication
(10) Pub. No.: US 2025/0173472 A1
(43) Pub. Date: May 29, 2025

(54) SUPPORT APPARATUS, DESIGN SUPPORT METHOD, AND STORAGE MEDIUM THAT STORES DESIGN SUPPORT PROGRAM

(71) Applicant: Hitachi, Ltd., Tokyo (JP)

(72) Inventors: Yuki ITABAYASHI, Tokyo (JP); Makoto ONODERA, Toyko (JP); Yosuke UEKI, Tokyo (JP)

(21) Appl. No.: 18/950,457

(22) Filed: Nov. 18, 2024

(30) Foreign Application Priority Data
Nov. 28, 2023 (JP) 2023-200570

(51) Int. Cl. G06F 30/12; G06F 111/04

(52) U.S. Cl. CPC G06F 30/12; G06F 2111/04

(57) ABSTRACT

A design support apparatus 10 for supporting a design for a product includes: a storage unit configured to store design information; an input unit 100 configured to receive the design information; a shape information extraction unit 101 configured to extract, from the design information, shape information indicating a shape and an arrangement of each of components constituting the product and attribute information indicating an attribute of each of components; an inter-component relation calculation unit 102 configured to calculate, based on the extracted shape information, inter-component information indicating relation between components of an own component that is a specified component and another component among the components constituting the product; and a requirement specification estimation unit 103 configured to estimate, based on the calculated inter-component information and the attribute information, a requirement specification required for the own component.

### CLAIM OF PRIORITY

The present application claims priority from Japanese Patent Application JP 2023-200570 filed on Nov. 28, 2023, the content of which are hereby incorporated by references into this application.

### BACKGROUND OF THE INVENTION

### 1. Field of the Invention

The present invention relates to a technique for supporting a review of a design proposal of a product.

### 2. Description of Related Art

In recent years, manufacturing industry is required to reduce an environmental load related to a product and manufacturing thereof. In addition to the above, it is necessary to review a design proposal that satisfies a plurality of requirement specifications such as product performance, cost, and reliability based on a customer requirement. The requirement specification may also be determined by an influence between components constituting the product in addition to the customer request. For example, a component that is close to a heat source such as a heater or a circuit board among components of a certain product is required to have heat resistance as a requirement specification such that this component can withstand a temperature rise caused by heat generation. In the future, it is expected that the type and the number of items of the requirement specification to be satisfied are increased as a correspondence to an environmental regulation, a legal regulation, and the like is stricter.

In order to implement a design proposal that satisfies the requirement specification as described above, in principle, it is necessary to grasp a requirement specification corresponding to all components constituting the product, and to review the design proposal that satisfies the requirement specifications. For example, JP2022-091253A (Patent Literature 1) discloses that determination of a design specification of a steel pipe for a hollow member having a life required according to a component design is supported. Specifically, first, a stress state of the hollow member during use is predicted based on a design load and a design shape of the hollow member using the steel pipe. Next, a predicted fatigue life of the hollow member is obtained based on a steel composition, a heat treatment condition, an inner surface shape, and the design shape of the steel pipe for the hollow member, and the predicted fatigue life of the hollow member is compared with a required fatigue life of the hollow member. As a result, when the predicted fatigue life is equal to or longer than the required fatigue life, the steel composition, the heat treatment condition, the inner surface shape, and the design shape of the steel pipe for the hollow member are determined as the design specification. Furthermore, Patent Literature 1 discloses that, when the predicted fatigue life is shorter than the required fatigue life, one or more of the steel composition, the heat treatment condition, the inner surface shape, and the design shape are changed, and the determination is restarted from a prediction step.

### CITATION LIST

### Patent Literature

Patent Literature 1: JP2022-091253A

### SUMMARY OF THE INVENTION

In Patent Literature 1, in order to satisfy a use condition and a required fatigue life of a hollow member using a steel pipe, a material and a shape of the steel pipe are optimized. The use condition and the required fatigue life are based on a predefined condition, and are not intended to estimate anything like a type or an item of a requirement specification. In order to optimize a material and a shape that are specifically for the steel pipe, a design specification is determined for various design parameters such as an inner shape and a design shape. Therefore, it is difficult to estimate the requirement specification for a plurality of components constituting a product while taking into account relation between the components. Here, the relation between the components refers to, for example, adjacency relation between a component and a component, and a component attribute such as a component name, and Patent Literature 1 cannot identify a requirement specification required for an own component based on the information.

Accordingly, an object of the invention is to implement estimation of a requirement specification required for the product or the component.

In order to solve the above problem, in the invention, inter-component relation indicating relation between components and attribute information are identified based on design information, and a requirement specification of each of components constituting a product is estimated based on the above information. The design information can be a 3D-CAD shape of the product that is a design target.

A more specific configuration is a design support apparatus for supporting a design for a product. The design support apparatus includes: a storage unit configured to store design information; an input unit configured to receive the design information; a shape information extraction unit configured to extract, from the design information, shape information indicating a shape and an arrangement of each of components constituting the product and attribute information indicating an attribute of each of components; an inter-component relation calculation unit configured to calculate, based on the extracted shape information, inter-component information indicating relation between components of an own component that is a specified component and another component among the components constituting the product; and a requirement specification estimation unit configured to estimate, based on the calculated inter-component information and the attribute information, a requirement specification required for the own component.

The invention also provides a design support method using the design support apparatus, a program for causing the design support apparatus to function, and a storage medium that stores the program. The invention also provides a design support system including the design support apparatus and a design support method using the design support system.

The product of the invention refers to a design target, and includes the component, a module, a unit, an assembly, an apparatus, a device, a system, and the like. The component is a composition element constituting the product, and includes the module, the unit, the assembly, and the like.

According to the invention, the requirement specification required for the component constituting the product can be easily estimated. As a result, unintended performance degradation caused by recognition omission of the requirement specification can be prevented or reduced, and an efficient review of a design proposal can be supported.

### BRIEF DESCRIPTION OF THE DRAWINGS

FIG. 1 is a functional block diagram of a design support apparatus 10 according to a first example.

FIG. 2 is a flowchart illustrating a processing procedure of the design support apparatus 10 according to the first example.

FIG. 3 is a diagram illustrating a GUI screen of a CAD model according to the first example.

FIG. 4 is a diagram illustrating a GUI screen of a CAD model according to the first example.

FIG. 5 is a diagram illustrating an example of shape information 155 extracted by a shape information extraction unit 101 according to the first example.

FIG. 6 is a diagram illustrating an example of attribute information 156 extracted by the shape information extraction unit 101 according to the first example.

FIG. 7 is a diagram illustrating an example of inter-component information 157 calculated by an inter-component relation calculation unit 102 according to the first example.

FIG. 8A is a diagram illustrating an example of a GUI screen of estimated requirement specifications according to the first example.

FIG. 8B is a diagram illustrating an example of a GUI screen of the estimated requirement specifications according to the first example.

FIG. 9 is a diagram illustrating an example of a term dictionary 158 according to the first example.

FIG. 10 is a system configuration diagram of a design support system 1 that is an implementation example according to a second example.

### DESCRIPTION OF EMBODIMENTS

Hereinafter, an embodiment according to the invention is described with reference to the drawings. In the present embodiment, rework caused by a design change in a design for a product can be prevented or reduced. Here, in the design, it is unrealistic to manually grasp requirement specifications associated with all components constituting the product, and when the requirement specification is unintentionally overlooked, a check is omitted without noticing performance degradation before and after the design change. Therefore, as a result, there is a risk that insufficient heat resistance temperature, insufficient strength, and the like are discovered in a subsequent process of the design, leading to the rework.

Therefore, in the present embodiment, the requirement specification required for the components constituting the product is estimated and presented. More specifically, a design support apparatus 10 according to the present embodiment estimates a requirement specification required for an own component based on relation between the own component and another component among components constituting a product, and prevents rework caused by a defect occurring in a subsequent process due to omission of the requirement specification. As a result, creation of a design proposal can be efficiently supported. Examples that are specific examples of the present embodiment are described below.

### First Example

In the first example, a coffee maker is described as an example of the product.

### Configuration of Device

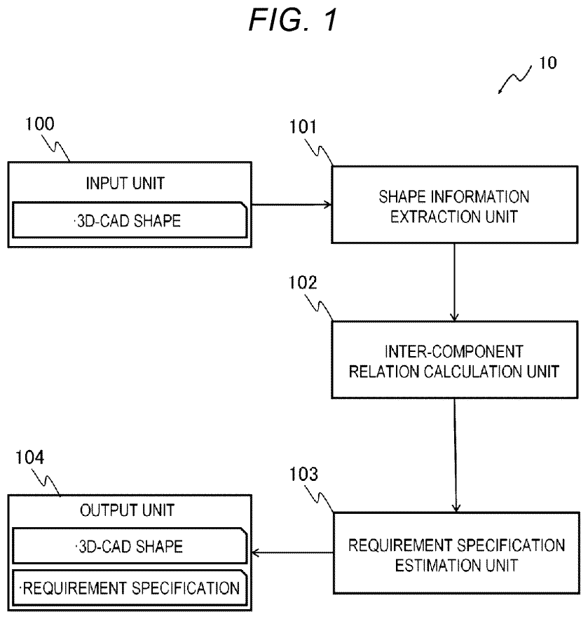

FIG. 1 is a functional block diagram of the design support apparatus 10 according to the first example. The design support apparatus 10 estimates a requirement specification required for components constituting a coffee maker that is the product, and presents the requirement specification to a user. For this purpose, the design support apparatus 10 includes an input unit 100, a shape information extraction unit 101, an inter-component relation calculation unit 102, a requirement specification estimation unit 103, and an output unit 104. First, the input unit 100 receives a 3D-CAD shape of the entire coffee maker or the components constituting the coffee maker. Here, the 3D-CAD shape is an example of design information. The design support apparatus 10 preferably further includes a storage unit that stores the design information represented by the 3D-CAD shape. Alternatively, the storage unit may be implemented by an apparatus different from the design support apparatus 10.

The shape information extraction unit 101 extracts shape information and attribute information of the components constituting the coffee maker from the received 3D-CAD shape. Here, the shape information is information related to a shape and an arrangement of the coffee maker that is a design target and each of the components constituting the coffee maker, and includes information related to the shape such as a geometric constraint condition, a dimension value, and a gravity center position. The attribute information is information indicating an attribute related to the component, and the attribute information (also referred to as 3DA information) related to the component such as a component name and a material type is associated with the 3D-CAD shape. The inter-component relation calculation unit 102 calculates, based on the extracted shape information, inter-component information indicating relation between components such as proximity relation and arrangement relation between the components regarding a specified component among the components of the coffee maker. The inter-component relation calculation unit 102 may calculate the inter-component information related to the components constituting the coffee maker.

The requirement specification estimation unit 103 estimates a requirement specification required for the specified component based on the calculated inter-component information and the attribute information. The output unit 104 outputs at least the requirement specification obtained by the requirement specification estimation unit 103. The requirement specification estimation unit 103 preferably regards the specified component as the own component and a component having proximity relation with the specified component as another component, refers to attribute information of the own component and the other component, and estimates a requirement specification or a candidate of the requirement specification required for the own component based on relation between the attribute information and the proximity relation, and the like. Hereinafter, the requirement specification or the candidate of the requirement specification is simply referred to as the requirement specification. The output unit 104 may output a combination result including a corresponding component and the requirement specification, and the 3D-CAD shape. The output unit 104 may be implemented as a communication unit that communicates the requirement specification or a display unit that displays the requirement specification.

### Processing Flow

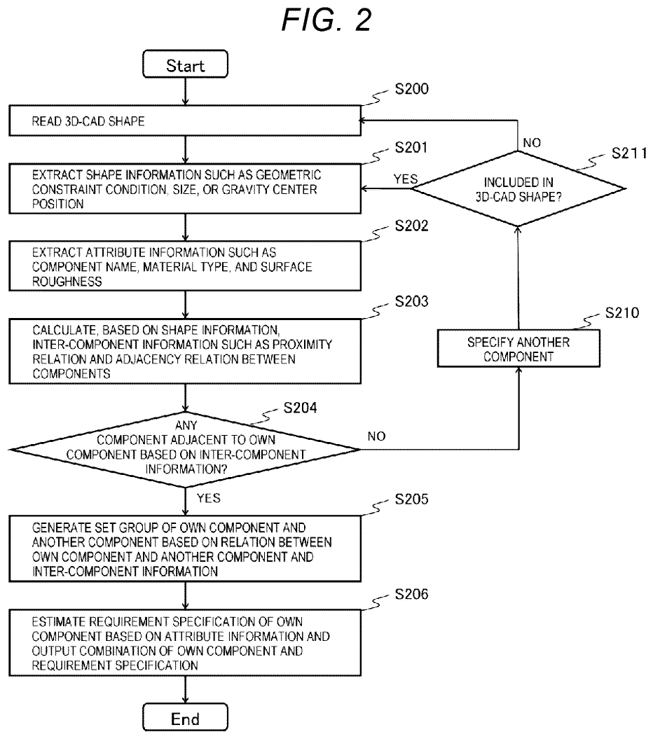

Next, a processing flow according to the first example is described. FIG. 2 is a flowchart illustrating a processing procedure of the design support apparatus 10 according to the first example.

First, the shape information extraction unit 101 reads the 3D-CAD shape received by the input unit 100 (step S200). The 3D-CAD shape includes the shape information and the attribute information. Here, the shape information is information related to the shapes of the coffee maker and the components constituting the coffee maker, and can be the geometric constraint condition, the dimension value, the gravity center position, and the like. The attribute information is information related to an attribute of the coffee maker and each of the components constituting the coffee maker, and can be the component name, the material type, a function thereof, a feature thereof, and the like. The attribute information can be so-called 3D annotated (3DA). The shape information extraction unit 101 may read a 3D-CAD shape of a component (own component) specified by the user, and for this purpose, the input unit 100 may receive the 3D-CAD shape of the own component.

Next, the shape information extraction unit 101 extracts the shape information from the read 3D-CAD shape (step S201). At this time, the extraction may be executed using an existing function on a 3D-CAD software or a dedicated processing program for extracting a feature of a geometric shape.

Next, the shape information extraction unit 101 extracts the attribute information from the read 3D-CAD shape (step S202). In general, the 3D-CAD shape has a function of registering the component name, the material type, and the like. Therefore, the attribute information can be extracted using an existing function on a macro or the 3D-CAD software. When the read 3D-CAD shape does not include the attribute information, the user may be prompted to register the component name, the material type, and the like. Therefore, the shape information extraction unit 101 determines whether the read 3D-CAD shape includes the attribute information, and when the read 3D-CAD shape does not include the attribute information, the output unit 104 outputs information for prompting registration of the attribute information.

The next step S203 and the subsequent steps are processing of the inter-component relation calculation unit 102. The inter-component relation calculation unit 102 executes each step using the shape information extracted by the shape information extraction unit 101. Specifically, the inter-component relation calculation unit 102 calculates, based on the shape information, inter-component information such as the proximity relation, an adjacency relation, and the arrangement relation between the components (step S203). Here, the inter-component refers to between the own component and another component, or between the components constituting the coffee maker. At this time, regarding the inter-component, the adjacency relation between the components can be grasped based on a constraint condition such as a fastening condition and a matching condition, and the proximity relation can be grasped by comparing the gravity center positions.

In addition to the adjacency relation and the proximity relation, the feature of the geometric shape in the shape information of the own component can also be used. In this case, it is also possible to grasp arrangement relation related to a component layout, such as whether a certain specific component has a design shape of an outer surface of the product, or the like, and the relation between the components may be obtained by various calculation processes. That is, the inter-component relation calculation unit 102 calculates the inter-component information including the arrangement relation indicating whether the own component has a design shape of the outer surface of the product.

Next, the inter-component relation calculation unit 102 determines, based on the calculated inter-component information, whether there is another component that has relation (proximity relation and adjacency relation) satisfying a predetermined condition with the own component (step S204). As a result, when there is another component satisfying the predetermined condition (YES), the process proceeds to step S205. On the other hand, when there is no another component satisfying the predetermined condition (NO), the process proceeds to step S210. Here, the own component may be specified in this step or may be specified in advance. The inter-component relation calculation unit 102 executes processing for prompting to specify another component as the own component (step S210). For example, the inter-component relation calculation unit 102 outputs, via the output unit 104, information for prompting to specify the other component as the own component.

Then, the inter-component relation calculation unit 102 determines whether the own component specified according to step S210 is included in the 3D-CAD shape read in step S200 (step S211). As a result, if the own component is included in the 3D-CAD shape (YES), the process proceeds to step S201. If the own component is not included in the 3D-CAD shape (NO), the process proceeds to step S200. In this case, the 3D-CAD shape including the specified own component is received by the input unit 100, and is read by the shape information extraction unit 101.

Hereafter, in step S205 and the subsequent step, the requirement specification estimation unit 103 executes processing on a result of the shape information extraction unit 101 and the inter-component relation calculation unit 102. First, regarding the own component, the requirement specification estimation unit 103 executes processing for generating, based on the inter-component information, a set group of the own component and another component having the proximity relation or the adjacency relation with the own component (step S205). Here, the adjacency relation can be relation in which there is no component between the components, such as a direct connection between the own component and the other component, or relation in which the number of components between the components is equal to or less than a predetermined number. Therefore, the adjacency relation can be determined based on whether a distance between the components is equal to or less than a predetermined adjacency threshold. The proximity relation can be, for example, relation in which the distance between the components is equal to or less than a proximity threshold. The proximity threshold is a value greater than the adjacency threshold. The proximity threshold and the adjacency threshold are preferably set in advance in the storage unit or the like.

Next, the requirement specification estimation unit 103 refers to the attribute information of the own component and the other component that constitute the generated set group, and estimates the requirement specification required for the own component. Then, the requirement specification estimation unit 103 creates and outputs a combination including the estimated requirement specification (step S206). Here, an example of more specific processing contents in steps S205 and S206 is described.

First, in step S205, the requirement specification estimation unit 103 searches for, based on the inter-component information obtained by the inter-component relation calculation unit 102, another component that has the proximity relation or the adjacency relation with one own component from the 3D-CAD shape. Then, the requirement specification estimation unit 103 generates a set in which another component corresponds to the own component. The other component is a result of the search. At this time, in the set, the own component and the other component are preferably in a one-to-one correspondence. Alternatively, the own component and the other component may be in a one-to-N correspondence or an M-to-N correspondence. A threshold (proximity threshold and adjacency threshold) defining the proximity relation or the adjacency relation may be defined based on, for example, a representative dimension of the product. According to the specification from the user executed via the input unit 100, the inter-component relation calculation unit 102 can change the threshold. That is, the threshold for determining the strength (degree) of the relation between the components can be made variable.

Regarding the set, for example, a set of an own component A and another component B that has the adjacency relation with the own component A is generated as own component A—the other component B. A plurality of sets of the own component A and another component C that has the proximity relation with the own component A may be generated as own component A—the other component C. Here, in general, a plurality of sets regarding the own component are often generated. Therefore, hereinafter, the set is referred to as the set group, and the number of sets may be singular.

In step S206, the requirement specification estimation unit 103 refers to, based on the attribute information obtained by the shape information extraction unit 101, the attribute information associated with the components such as the component name and the material type, which is the attribute information of the own component and the other component. In response, the requirement specification estimation unit 103 estimates, based on the attribute information, the requirement specification required for the own component. Then, the requirement specification estimation unit 103 combines the 3D-CAD shape of the own component and the estimated requirement specification and outputs the combination by the output unit 104. Here, the requirement specification may be estimated, by using a natural language processing technology, from requirement specifications that have a high appearance frequency in past performance or from requirement specifications that have a track record of application in a same set. Further, a requirement specification associated with the attribute information may be estimated with reference to a database in which the requirement specification is stored. For example, the component name, which is the attribute information of the other component B, is assumed to be “heater” in the above own component A—the other component B. In this case, heat resistance is estimated as a requirement specification required for the own component A. The own component A is close to the “heater” that is the other component B, that is, a heat source. Information that the “heater” is the heat source may be recognized using a dictionary by registering the information in the dictionary as a term.

In the above processing flow, the proximity relation and the adjacency relation are used as the inter-component information. Alternatively, similarity information indicating similarity between the own component and the other component may also be used. More specifically, the inter-component relation calculation unit 102 calculates the similarity information indicating the similarity between the own component and the other component, and identifies another component within a preset similarity threshold. Further, according to this processing flow, a design (shape, attribute, and the like) of the own component can be changed. For example, in response to a change instruction from the user received by the input unit 100, the requirement specification estimation unit 103 or a design unit (not illustrated) changes a design of the own component and updates a 3D-CAD shape 154. When the own component is changed in this way and the changed own component becomes another component, each step of this processing flow is executed using the changed 3D-CAD shape 154. The processing flow according to the first example is described above. Next, GUI according to the first example and information used in the first example are described.

### GUI and Information

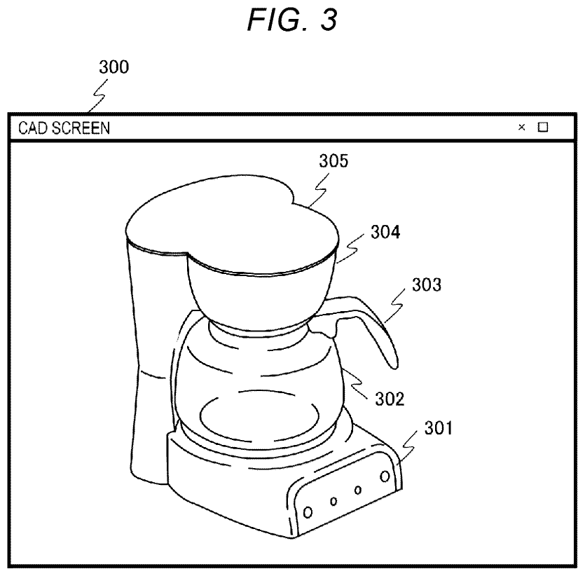

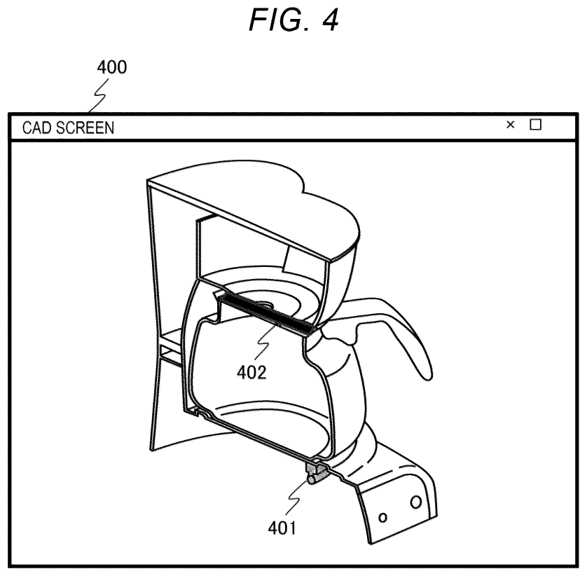

FIGS. 3 and 4 are diagrams illustrating GUI screens of a CAD model simulating the coffee maker according to the first example. First, a GUI screen 300 illustrated in FIG. 3 displays an overall image of the CAD model of the coffee maker. A GUI screen 400 illustrated in FIG. 4 displays a cross-sectional view of the CAD model of the coffee maker. Here, as illustrated in FIG. 3, the coffee maker which is the design target according to the first example includes components which are a base body 301, a pod 302, a handle 303, a tank 304, and a tank cover 305. In addition to the above components, the coffee maker further includes a heater 401 and a pod cover 402 as illustrated in FIG. 4. The above GUI screens in FIGS. 3 and 4 are displayed on a display unit that is an example of the output unit 104. In the present example, an example of estimating a requirement specification required for the base body 301 for the coffee maker illustrated in the drawings is described below. That is, the base body 301 is the own component.

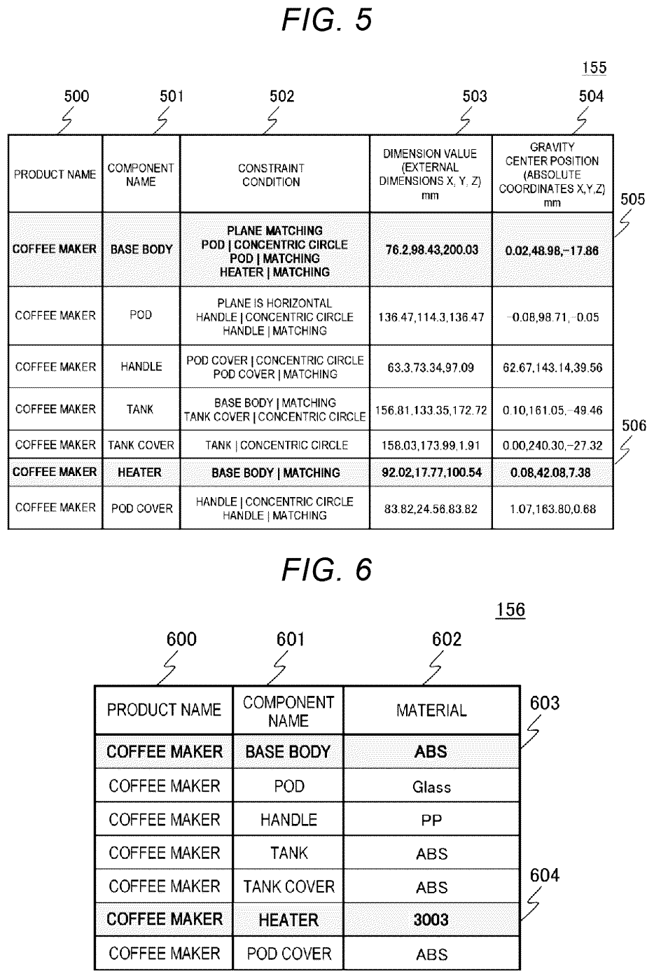

Next, the information used in the first example is described. FIG. 5 is a diagram illustrating an example of shape information 155 extracted by the shape information extraction unit 101 according to the first example. The shape information 155 is information related to shapes of the coffee maker and the components constituting the coffee maker. In the present example, the shape information 155 includes, for example, items which are a product name 500, a component name 501, a constraint condition 502, a dimension value 503, and a gravity center position 504.

The product name 500 relates to a name of the product that is the design target and that includes the components. In the present example, as described above, the coffee maker is recorded as the product name 500. The component name 501 relates to a component name of the component constituting the product. In the present example, a base body, a pod, and the like as described with reference to FIG. 3 are recorded.

The constraint condition 502 relates to a condition indicating fastening states between the corresponding component and other components and matching of a position of the corresponding component. For example, in a record 505 of the corresponding component, as the constraint condition 502 of the base body, conditions of plane matching, concentric circle and matching with respect to the pod component, and matching with respect to the heater component are recorded. The plane matching refers to a condition in which a lower end surface of the component matches a horizontal surface. In a record 506, a condition of matching with respect to the base body that is the other component is recorded as the constraint condition 502 of the heater.

The dimension value 503 relates to external dimensions of the corresponding component. The gravity center position 504 relates to a gravity center position having absolute coordinates of the corresponding component during assembly. Here, by using the gravity center position 504, positional relation of the components can be grasped. For example, it is understood that a distance between the base body and the heater is small based on positional relation between the gravity center positions of the base body and the heater. From the above, the matching in the constraint condition is defined between the base body and the heater, and it is understood based on the shape information that the distance between the components is small.

FIG. 6 is a diagram illustrating an example of attribute information 156 extracted by the shape information extraction unit 101 according to the first example. The attribute information 156 indicates attributes of the components constituting the product that is the design target. Therefore, the attribute information 156 includes, for example, items which are a product name 600, a component name 601, and a material 602. The product name 600 and the component name 601 are the same items as the shape information 155 illustrated in FIG. 5. The material 602 indicates a material of the corresponding component. For example, in a record 603, the material 602 of the base body is recorded to be ABS that is a resin material. In a record 604, an aluminum alloy 3003 is recorded as the material 602 of the heater.

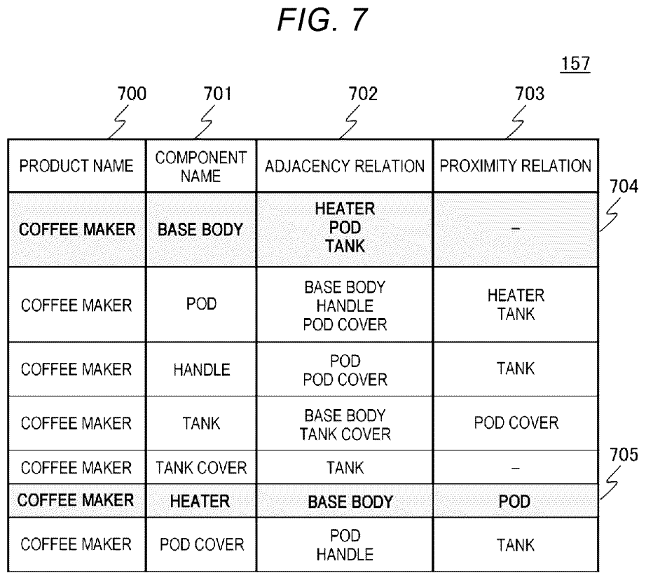

FIG. 7 is a diagram illustrating an example of inter-component information 157 calculated by the inter-component relation calculation unit 102 according to the first example. The inter-component information 157 indicates the relation between the components, and is calculated based on the constraint condition, the gravity center position, and the like of the shape information 155 illustrated in FIG. 5. Therefore, for example, the inter-component information 157 includes items which are a product name 700, a component name 701, an adjacency relation 702, and a proximity relation 703. The product name 700 and the component name 701 are the same items as the shape information 155 illustrated in FIG. 5. The adjacency relation 702 indicates a component (another component) that is connected with the corresponding component (own component) with a distance of zero (direct connection) or that interferes with the corresponding component. To calculate the adjacency relation 702, that is, to identify the component having the adjacency relation 702, the constraint condition 502 of the shape information 155 included in the 3D-CAD shape can be used for each component. That is, the other component recorded in the constraint condition 502 of the components can be identified as the components having the adjacency relation 702. Further, the adjacency relation 702 may be obtained by executing interference determination for each component using the shape information 155. More specifically, it is possible to determine whether the components interfere with each other by using the dimension value 503 and the gravity center position 504.

The proximity relation 703 indicates a component that is not connected with the corresponding component with the distance in the adjacency relation or does not interfere with the corresponding component, but has a small distance to the corresponding component. That is, a component is illustrated whose distance to the corresponding own component is equal to or less than the threshold. The threshold of the distance is defined based on the representative dimension of the product or the like. Alternatively, the threshold may be defined by the user. The calculation of the proximity relation 703, that is, the identification of the other component having the proximity relation with the corresponding own component, can be executed by generating a straight line in a normal direction from a surface of a component surface constituting the own component and determining whether there is another component that interferes with the straight line.

For example, in a record 704, three components which are the heater, the pod, and the tank are recorded as components having the adjacency relation with the base body. Further, it is recorded that there is no component having the proximity relation with the base body. In a record 705, the base body is recorded as a component having the adjacency relation with the heater, and the pod is recorded as a component having the proximity relation with the heater.

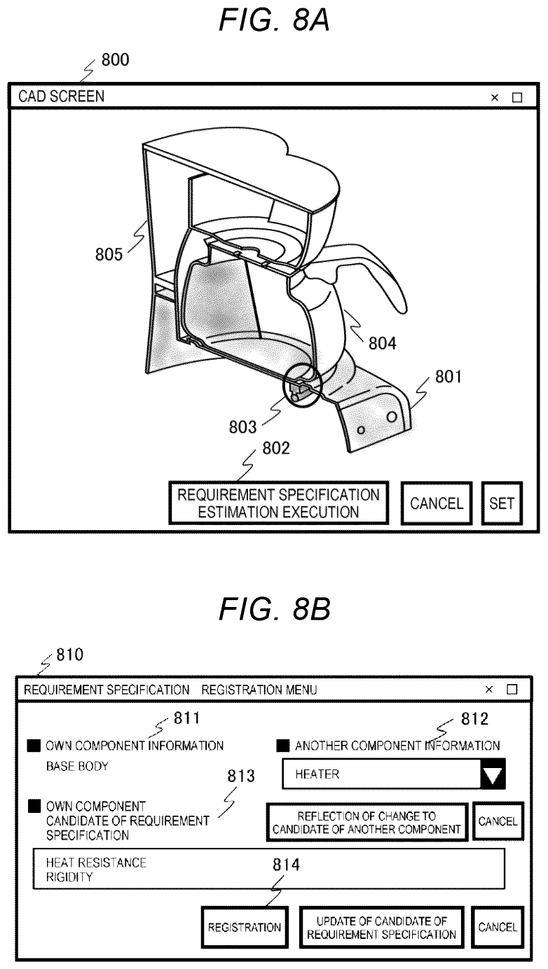

FIGS. 8A and 8B are diagrams illustrating examples of GUI screens of the estimated requirement specifications according to the first example. FIG. 8A is a GUI screen 800 illustrating a cross-sectional view of a CAD model of a coffee maker that is a subject of the requirement specification. FIG. 8B is a requirement specification registration menu screen 810 that is displayed when the requirement specification is estimated.

The user first selects a base body 801 of the coffee maker as the own component via the GUI screen 800, and presses a requirement specification estimation execution button 802. As a result, the requirement specification estimation unit 103 executes estimation of the requirement specification. That is, step S205 and step S206 are executed. Next, the requirement specification estimation unit 103 causes the requirement specification registration menu screen 810 to be displayed via the output unit 104. In the requirement specification registration menu screen 810, the base body 801 specified as the own component is displayed in own component information 811. In another component information 812, a heater 803 having the adjacency relation with the own component, which is indicated in the corresponding record 704 in FIG. 7, is displayed. In the other component information 812, it is possible to select a candidate of the component having the adjacency relation with the own component other than the heater as the other component. For example, the pod 804 and the tank 805 also have the proximity relation with the own component, and it is also possible to change the other component to reflect this change in display.

Then, an estimation result of the requirement specification is displayed in a requirement specification 813 for the own component. Here, the heat resistance and rigidity are displayed as the requirement specification of the base body 801 that is the own component, based on the relation between the components of the own component and the other component, the attribute information, and the like. Since the heater has the adjacency relation with the base body, the base body is required to have the heat resistance that can withstand a temperature rise caused by the heater. There are a plurality of components having the adjacency relation with the base body, and it is highly likely that the base body is a structure that supports the component other than the own component as illustrated in the constraint condition and the gravity center position in FIG. 5. Therefore, it is understood that the rigidity is also required. For the estimation, the requirement specification may be presented using a term dictionary 158 to be described later, which is described later in detail.

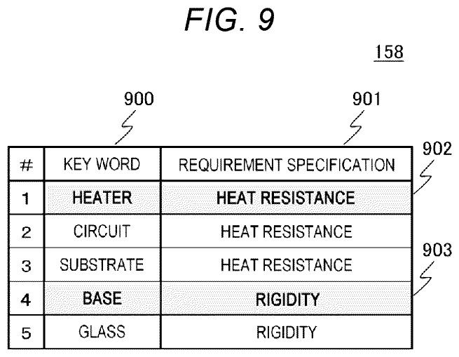

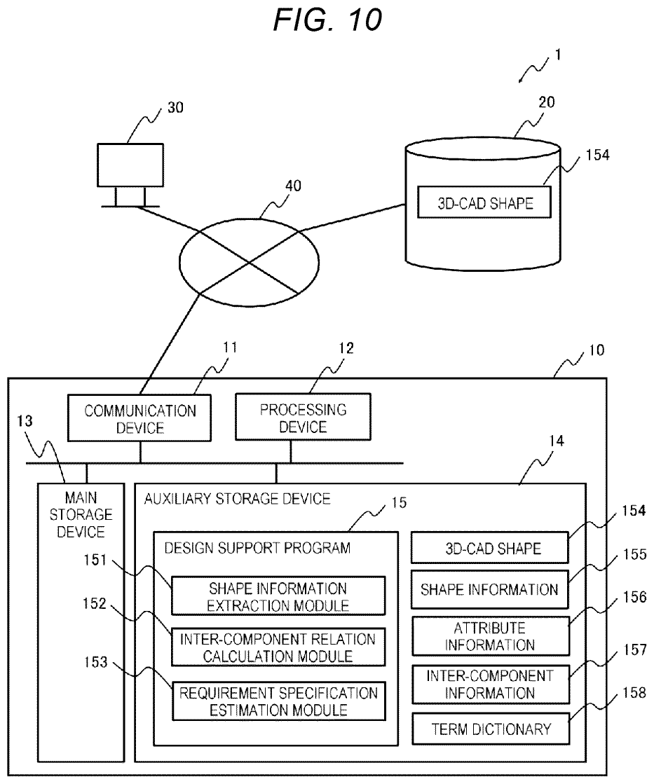

As described above, the user can review the design proposal after checking the requirement specification of the base body that is the presented own component, which can prevent the omission of the required specification. Next, the term dictionary 158 used for the estimation of the requirement specification is described. FIG. 9 is a diagram illustrating an example of the term dictionary 158 according to the first example. The term dictionary 158 includes items which are a key word 900 and a requirement specification 901 related to the component and the product. As a result, the requirement specification 901 corresponds to the key word 900. For example, as illustrated in FIG. 9, the “heater” and the “heat resistance” are associated with each other in a record 902, and a “base” and the “rigidity” are associated with each other in a record 903. In the key word 900, the component name or the product name itself may be used, or the attribute information of the component may be used.

Here, since the “base” that is the key word in the record 903 includes a part of the “base body” that is the component, when the base body is identified as the own component or the other component, the “rigidity” is estimated as the requirement specification. More specifically, as shown in FIG. 8B, the heat resistance and the rigidity are estimated as requirement specifications required for the “base body” having the adjacency relation with the “heater”, that is, the heat source.

The information that the “heater” is the heat source may be registered in the term dictionary 158, and the requirement specification may be estimated by using the term dictionary 158.

As described above, by estimating the requirement specification required for the components constituting the product, unintended performance degradation at the time of design change occurring in the subsequent process due to recognition omission of the requirement specification can be prevented in advance, and an efficient review of the design proposal can be supported.

### Second Example

Next, an implementation example of the above design support apparatus 10 is described as the second example. Hereinafter, a design support system 1 in which functions of the design support apparatus 10 are implemented in a server is described as an example. In this case, the functions can be implemented in a so-called cloud system or on-premise. Alternatively, the design support apparatus 10 may also be implemented in a terminal device or the like other than the server.

FIG. 10 is a system configuration diagram of the design support system 1 that is the implementation example according to the second example. The design support system 1 includes the design support apparatus 10, a database 20, and a terminal device 30, which are connected to each other via a network 40. The design support apparatus 10 and the terminal device 30 can be implemented by a computer that executes processing according to a program. Alternatively, the design support apparatus 10 and the terminal device 30 may be implemented by dedicated hardware or the like instead of the program.

The design support apparatus 10 includes a communication device 11, a processing device 12, a main storage device 13, and an auxiliary storage device 14. These devices are connected to each other via an internal communication path such as a bus. Hereinafter, each configuration is described.

The communication device 11 has a function of connecting various configurations of the design support apparatus 10 to other apparatuses via the network 40. The network 40 may be of any type, such as the Internet, as long as the network 40 has a communication function. The communication device 11 can implement functions of the input unit 100 and the output unit 104 in FIG. 1.

The processing device 12 is implemented by a processor such as a CPU. That is, analysis processing is executed according to a program stored or loaded in the main storage device 13.

The main storage device 13 is implemented by a storage medium such as a memory. The main storage device 13 loads a program that is stored in the auxiliary storage device 14 and that is used for executing processing of the processing device 12. In this way, in general, each program is preferably stored in another storage device such as the auxiliary storage device 14, and the storage medium.

The auxiliary storage device 14 stores various kinds of information and various programs. The various kinds of information include the 3D-CAD shape 154, the shape information 155, the attribute information 156, the inter-component information 157, and the term dictionary 158. The various kinds of information may be stored in the database 20 other than the design support apparatus 10. In FIG. 10, the 3D-CAD shape 154 is stored in the database 20, and other information may also be stored in the database 20. The database 20 may be omitted.

The program stored in the auxiliary storage device 14 is a design support program 15. This is a program for executing each process described in the first example. Therefore, the design support program 15 includes a shape information extraction module 151, an inter-component relation calculation module 152, and a requirement specification estimation module 153. Accordingly, the processing device 12 executes the processes of the shape information extraction unit 101, the inter-component relation calculation unit 102, and the requirement specification estimation unit 103 according to the design support program 15. Each of the modules may be implemented by an independent program.

The auxiliary storage device 14 can be implemented by a hard disk drive (HDD), a solid state drive (SSD), various optical disks, or the like.

The terminal device 30 is used by the user and has the functions of the input unit 100 and the output unit 104. The input unit 100 can be implemented by an input device such as a keyboard or a pointing device, and receives a user operation. The output unit 104 can be implemented by a display device that displays the estimated requirement specification, that is, a processing result of the processing device 12 such as the above various GUI screens.

The examples are described above, but the invention is not limited to the examples. For example, the design target can be applied to an information system other than the product such as a coffee maker. The design target may be a design target having different number of hierarchical levels other than the design target having two hierarchical levels such as the component and the product. For example, the invention can be applied to a design target such as component-subassembly-unit-product. In this case, the shape information 155, the attribute information 156, the inter-component information 157, and the term dictionary 158 include items of each hierarchical level.

What is claimed is:

1. A design support apparatus for supporting a design for a product, the design support apparatus comprising:
a storage unit configured to store design information;
an input unit configured to receive the design information;
a shape information extraction unit configured to extract, from the design information, shape information indicating a shape and an arrangement of each of components constituting the product and attribute information indicating an attribute of each of components;
an inter-component relation calculation unit configured to calculate, based on the extracted shape information, inter-component information indicating relation between components of an own component that is a specified component and another component among the components constituting the product; and
a requirement specification estimation unit configured to estimate, based on the calculated inter-component information and the attribute information, a requirement specification required for the own component.

2. The design support apparatus according to claim 1, wherein
the inter-component relation calculation unit calculates proximity relation and adjacency relation with the other component as the inter-component information.

3. The design support apparatus according to claim 2, wherein
the proximity relation and the adjacency relation are determined according to a preset threshold, and
the inter-component relation calculation unit changes the threshold.

4. The design support apparatus according to claim 1, wherein
the inter-component relation calculation unit calculates, by using a feature of a geometric shape of the own component, the inter-component information including arrangement relation indicating whether the own component has a design shape of an outer surface of the product.

5. The design support apparatus according to claim 1, wherein
the inter-component relation calculation unit calculates similarity information indicating similarity with the other component as the inter-component information.

6. A design support method using a design support apparatus for supporting a design for a product, the design support method comprising:
storing design information in a storage unit;
receiving the design information by an input unit;
extracting, from the design information, shape information indicating a shape and an arrangement of each of components constituting the product and attribute information indicating an attribute of each of components by a shape information extraction unit;
calculating, based on the extracted shape information, inter-component information indicating relation between components of an own component that is a specified component and another component among the components constituting the product by an inter-component relation calculation unit; and
estimating, based on the calculated inter-component information and the attribute information, a requirement specification required for the own component by a requirement specification estimation unit.

7. The design support method according to claim 6, wherein
the inter-component relation calculation unit calculates proximity relation and adjacency relation with the other component as the inter-component information.

8. The design support method according to claim 7, wherein
the proximity relation and the adjacency relation are determined according to a preset threshold, and
the inter-component relation calculation unit changes the threshold.

9. The design support method according to claim 6, wherein
the inter-component relation calculation unit calculates, by using a feature of a geometric shape of the own component, the inter-component information including arrangement relation indicating whether the own component has a design shape of an outer surface of the product.

10. The design support method according to claim 6, wherein
the inter-component relation calculation unit calculates similarity information indicating similarity with the other component as the inter-component information.

11. A storage medium that stores a design support program for causing a design support apparatus, which supports a design for a product and is a computer, to function as:
a storage unit configured to store design information;
an input unit configured to receive the design information;
a shape information extraction unit configured to extract, from the design information, shape information indicating a shape and an arrangement of each of components constituting the product and attribute information indicating an attribute of each of components;
an inter-component relation calculation unit configured to calculate, based on the extracted shape information, inter-component information indicating relation between components of an own component that is a specified component and another component among the components constituting the product; and
a requirement specification estimation unit configured to estimate, based on the calculated inter-component information and the attribute information, a requirement specification required for the own component.

12. The storage medium that stores the design support program according to claim 11, wherein
the inter-component relation calculation unit calculates proximity relation and adjacency relation with the other component as the inter-component information.

13. The storage medium that stores the design support program according to claim 12, wherein
the proximity relation and the adjacency relation are determined according to a preset threshold, and
the inter-component relation calculation unit changes the threshold.

14. The storage medium that stores the design support program according to claim 11, wherein
the inter-component relation calculation unit calculates, by using a feature of a geometric shape of the own component, the inter-component information including arrangement relation indicating whether the own component has a design shape of an outer surface of the product.

15. The storage medium that stores the design support program according to claim 11, wherein
the inter-component relation calculation unit calculates similarity information indicating similarity with the other component as the inter-component information.
